(19) United States
(12) Patent Application Publication
(10) Pub. No.: US 2025/0383635 A1
(43) Pub. Date: Dec. 18, 2025

(54) REINFORCEMENT LEARNING CONTROL OF MANUFACTURING EQUIPMENT

(71) Applicant: International Business Machines Corporation, Armonk, NY (US)

(72) Inventor: Cory Yee, San Jose, CA (US)

(21) Appl. No.: 18/743,024

(22) Filed: Jun. 13, 2024

(51) Int. Cl. G05B 13/02; G06N 20/00

(52) U.S. Cl. CPC G05B 13/0265; G06N 20/00

(57) ABSTRACT

A method, computer system, and a computer program product are provided. A reinforcement learning model that is installed in a controller of equipment is trained via the following steps that are described. A desired output of a first operation to be performed via the equipment is input into the reinforcement learning model. The equipment is caused to perform a manufacturing micro-action. Feedback from one or more sensors is recorded after the performance of the micro-action. The feedback is compared to the desired output to generate a score that is based on a closeness of the feedback to the desired output. A policy of the reinforcement learning model is updated based on the score. Micro-actions, feedback recording, comparison-based score generation, and policy updating are iteratively repeated multiple times such that the reinforcement learning model becomes a trained reinforcement learning model.

### BACKGROUND

The present invention relates generally to the fields of manufacturing, equipment used for manufacturing, machine learning, reinforcement learning as machine learning, and combining machine learning to improve equipment manufacturing performance and maintenance.

### SUMMARY

According to one exemplary embodiment, a computer-implemented method is provided. A reinforcement learning model that is installed in a controller of equipment is trained via the following steps that are described. A desired output of a first operation to be performed via the equipment is input into the reinforcement learning model. The equipment is caused to perform a manufacturing micro-action. Feedback from one or more sensors is recorded after the performance of the micro-action. The feedback is compared to the desired output to generate a score that is based on a closeness of the feedback to the desired output. A policy of the reinforcement learning model is updated based on the score. Micro-actions, feedback recording, comparison-based score generation, and policy updating are iteratively repeated such that the reinforcement learning model becomes a trained reinforcement learning model for guiding actions of the equipment. A computer system corresponding to the above method is also disclosed herein.

According to one exemplary embodiment, a computer program product is provided. The computer program product includes a set of one or more computer-readable storage media and program instructions, collectively stored on the set of one or more storage media, for execution by a processor set to cause computer operations to be performed. The computer operations include receiving input regarding one or more measurements for manufacturing equipment. The computer operations also include inputting the measurement into a reinforcement learning model to obtain a next-best action to perform via the manufacturing equipment on a load, the next-best action comprising one or more movements of one or more components of the equipment for manufacturing. The computer operations include causing the manufacturing equipment to automatically perform the obtained next-best action. The computer operations include iteratively receiving input regarding the manufacturing, receiving another next-best action based on the input, and causing the manufacturing equipment to perform the received next best action. The iteration results in the manufacturing equipment manufacturing a product.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a process for reinforcement learning-enhanced automated control of manufacturing equipment according to at least one embodiment.

FIG. 2 illustrates details according to at least one embodiment about a post-training run cycle of the process for reinforcement learning-enhanced automated control of manufacturing equipment that was shown in FIG. 1.

FIG. 3A illustrates details of change in surface roughness of diamond paper that is used to sand edges of a tape reader module according to one embodiment and whose effects are governed by reinforcement learning techniques described herein.

FIG. 3B illustrates another sample that shows change in surface roughness of diamond paper that is used to sand edges of a tape reader module according to one embodiment and whose effects are governed by reinforcement learning techniques described herein.

FIG. 3C shows a three-dimensional profile of a tape reader module whose edges are beveled according to one embodiment with the beveling process governed by reinforcement learning techniques described herein.

FIG. 3D shows an intensity view of the tape reader module whose edges are beveled according to one embodiment with the beveling process governed by reinforcement learning techniques described herein.

FIG. 4 illustrates a comparison of scores produced that are part of reinforcement learning model training before and after equipment maintenance according to one embodiment.

FIG. 5 illustrates use of the trained the reinforcement learning model to manage manufacturing cycles when parts variance occurs in a lapping process according to one embodiment.

FIG. 6 illustrates a networked computer environment in which reinforcement learning-enhanced automated control of manufacturing equipment is performed according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments. Reinforcement learning is a type of machine learning that addresses sequential decision-making problems that are typically under uncertainty.

Reinforcement learning is a learning paradigm in which the artificial intelligence learns to optimize sequential decisions, which are decisions that are taken recurrently across time steps, for example, multiple cycles of a manufacturing operation with manufacturing equipment. At a high level, reinforcement learning mimics how humans learn. Humans have the ability to learn strategies that help master complex tasks like swimming, gymnastics, or taking a test. Reinforcement learning broadly seeks inspiration from these human abilities to learn how to act. But more specifically to practical use cases, reinforcement learning seeks to acquire the best strategy for taking repeated sequential decisions across time in a dynamic system under uncertainty. The reinforcement learning does so by interacting with a stochastic dynamic system of interest, also called as an environment, to learn such winning strategies. A strategy to take repeated sequential decisions across time in a dynamic system is also called as a policy. Reinforcement learning tries to learn the winning policy, namely a winning recipe of how to take actions in different states of a dynamic system.

Reinforcement learning works in a mathematical framework that includes ingredients of:
A state space (or observation space): All available information and problem features that are useful for taking a decision. This includes fully known or measured variables (for example, the position and size of components of the manufacturing equipment and of the raw material that is processed via the manufacturing operation) as well as unmeasured variables for which only a belief or estimate is held.
An action space: Decisions that the agent can take in each state of the system.
A reward signal: A scalar signal that provides the necessary feedback about performance, and, therefore, the opportunity to learn which actions are beneficial in any given state. The learning is both local in its nature to learn immediate gain as well as long-term gain because actions that are taken in any state lead to future states where another action is taken and so on. The discounted cumulative reward signal is the optimization objective for reinforcement learning, making it focus on a long-term strategy that yields the best cumulative reward.

Most dynamic optimization problems as well as some deterministic discrete (combinatorial) optimization problems are naturally expressible in a state-action-reward framework. A dynamic system experiences (uncertain) transitions in the state space when actions are taken in any state to collect a local reward and propel the system forward in time. For example, a Markov Decision Process (MDP) model formalizes sequential decision-making in dynamic systems under uncertain transitions and rewards, and takes the form of a state-action-reward model.

Learning by reinforcement in dynamic systems under uncertain transitions and uncertain rewards combines two mutually reinforcing ideas: exploring new states and new state-action combinations, and using the resulting experience to improve the decision-making. Exploration and exploitation are the two fundamental ideas in reinforcement learning. Given enough time (that is, enough collection of experience), reinforcement learning can lead to a winning strategy (or a policy) that can be used for long-term decision-making in repeated decision-making problems.

Reinforcement learning is a framework for learning-based decision-making, where there is not samples available with ground truth labels. Instead, the reinforcement learning uses trajectories of tuples in the form of “current state-action-next state-reward” combinations that are serially interdependent, that is, the data is no longer a static tabular data set unlike supervised machine learning. The objective of the reinforcement learning is to produce a policy, namely, a mapping or strategy that computes the next best action to take, with the understanding that any action that the agent takes will influence future inputs into the policy mapping to compute the next-to-next best action and so on. This rolling influence makes the learning no longer focus exclusively on the current state, but also on the longer-term consequences on future states that come about downstream to the current action in question.

Reinforcement learning builds on experience in the form of serially coupled dynamic sequence of “state-action-next state-reward” tuples, that is, experience in the form of controlled dynamic trajectories along with reward in the state space and distilling that experience to learn how to optimally act.

As described previously, reinforcement learning allows for a modeling template for sequential problems. The reinforcement learning of the present embodiments helps to solve the problems of controlling action of the manufacturing equipment during a manufacturing operation. In some instances, the reinforcement learning augments the reward information with constraints that include a negative penalty for violation of each constraint of interest. Some variables of uncertainty of the manufacturing which include element randomness that is not in the control of the human technicians are also introduced into the reinforcement learning agent in some embodiments.

In manufacturing, e.g., in precision manufacturing, periodic maintenance of equipment often results in having to perform tedious re-calibration or tuning of the hardware. This effect occurs because the software is statically programmed and will behave exactly as told, resulting in a need to adjust the hardware within an acceptable tolerance so that the software can perform as intended. A moderate to high level of technical expertise by a technician is required to be able to tune or calibrate these tools. Such need for expertise especially occurs for custom equipment composed of multiple subsystems. One example is a semiconductor lapping process to control electrical resistance. Another is a high precision grinding or polishing process to yield specific surface flatness. High precision manufacturing equipment has its robotics controllers tuned for specific hardware setups. Maintenance and calibration for these equipment must be done in a fashion so that the equipment returns to a near identical state before the maintenance. As a result, maintenance and calibration for high precision equipment is difficult due to the high demand for equipment knowledge and expertise as well as the ability to manually align components to extremely small tolerances.

In one embodiment, the reinforcement learning techniques described herein are utilized to control a manufacturing process for a magnetic tape reader module. The magnetic tape stores data. The tape reader module includes several electromagnetic sensors which read electromagnetic data stored within the tape. The tape reader module itself needs a beveled head because the magnetic tape passes over the head with a certain speed as part of the data reading process. If the magnetic tape catches on a sharp corner, stiction problems occur where the tape becomes stuck on the reader module. Thus, in one embodiment the reinforcement learning techniques described herein govern movement of the manufacturing equipment that is used to modify the material of the tape reader module to produce the bevel in the head. A rough material such as diamond tape or sandpaper is moved across the tape module head while contacting the tape module head to remove material of the module head, to polish the edge of the module head, and to generate the bevel in the module head. The module head is a ceramic that can be shaped via a sanding process. The manufacturing tool takes a magnetic tape reader module and creates a 0.2 & −0.2 degree bevel on a 0.23 mm wide surface. A tension controlled belt grinder creates this surface. In one embodiment, an actuation arm with diamond tape moves back and forth like a two-directional belt sander to apply shaping and sanding to the module head to create the bevel. Other embodiments include a mechanical arm designed to generate a rotational movement for the diamond tape. The diamond tape that is used for grinding wears out over time and is required to be replaced every quarter, pending usage.

Because the individual components are small and are becoming increasing smaller, factors that were previously negligible start to increasingly dominate the process and to negatively impact equipment performance. The wear in the sanding material can result in drastic variations in the end result of the produced item. Such factors that can have a large influence include uncontrollable variables such as parts variations from suppliers. Controllable variables, as previously stated, often are highly difficulty with respect to precise adjustments or require equipment modifications, such as equipment alignment tolerances which tie into repeatability and reproducibility.

The present embodiments provide a method, a computer program product, and a computer system which integrate reinforcement learning techniques, such as Q-learning, into controlling equipment, e.g., for manufacturing, e.g., into a robotics controller. The integration reduces the human expertise that is needed to perform equipment maintenance or calibration. The embodiments provide flexible software that are adaptable to variations in hardware setup and that reduce the expertise that is required to set up and maintain manufacturing equipment. The controller, e.g., computer software controller, of the manufacturing equipment is programmed to be capable of teaching itself, allowing it to react to the changes of the equipment, or the environment, as perceived by the controller. Reinforcement learning such as Q-learning is used to generate an optimum policy based on various state-action pairs. Essentially, the training of the reinforcement learning, e.g., Q-learning, creates a trained machine learning model that can decide the next best action to take to reach a desired goal, based on exploration and feedback of sensors that are associated with the manufacturing equipment. The techniques described herein achieve the technical advantage of facilitating automated recalibration/setup of a physical manufacturing system without human intervention (if training in a degraded stated) or with minimal human intervention (if hardware change out is required). The reinforcement learning techniques described herein are especially helpful to govern manufacturing processes in which components of the automated equipment have a subtractive experience, e.g., they degrade over time. The present embodiments frontload compensation vectors and combine them into a reinforcement learning model that is used to govern control of equipment elements/components during manufacturing of products.

The embodiments described herein are applicable in a wide variety of manufacturing processes and equipment types.

Other manufacturing examples in which the reinforcement learning techniques described herein are implemented include the finishing of a product, for example polishing of a knife or blade edge (similar to the beveling process). The techniques are implemented in other embodiments to govern manufacturing equipment that automatically applies a coating to a surface, like applying an even coating of wax onto a surfboard. Another example is manufacturing which includes precisely dispensing an exact amount of a flowing substance (in which viscosity may change over time) with some liquid properties, such as epoxy or a chemical to be mixed.

In some embodiments, the reinforcement learning model training and usage techniques are implemented with automated manufacturing equipment to produce solar panels. For example, the training and model usage tasks described herein are implemented with the various equipment to produce the silicon wafers, e.g., via slicing, to apply a conductive paste to the wafers, e.g., a silver paste, to apply any adhesive layer, to apply wiring in the form of fingers or busbars, to provide an encapsulation sheath, etc.

In some embodiments, the reinforcement learning model training and usage techniques are implemented with automated manufacturing equipment to produce cell phones. The RL model training and trained model control occurs for various steps such as metal frame production via cutting, toughness increasing, interface and groove cutting, screw holes drilling sand blasting, plating, and anti-oxidation. The RL model training and trained model control occurs for other steps such as component retrieval and installation into the frame, battery installation, and display screen installation.

In some embodiments, the reinforcement learning to assist the manufacturing and control of manufacturing equipment includes the following features:
1) Programmable motion stages with precision movement below the product specification tolerances
2) a minimum of two process steps:
   a) A measuring step: occurs by measuring the load that is being processed and by verifying whether successful installation of the load occurred. The measuring step typically includes use of one or more sensors.
   b) A processing step: occurs via the tool impacting the load until specifications are met.
3) Sample load(s) to be explored.

With these features, an exploration mode is created for performing reinforcement learning for a reinforcement learning machine learning model. To have the controller re-teach itself, first a new “training mode” for the system is entered, a part/raw load that is modified to become the final project of a manufacturing operation is loaded into the manufacturing equipment, a scope of the operation is described and input into the controller, and then the system performs micro-actions to explore its new environment and to begin training the reinforcement learning model. The exploration mode occurs via the tool iterating between the measuring step and the processing step. However, the magnitude of the impact of each processing step that is a micro-action in the exploration mode is to be a fraction of the typical processing step, e.g.: if the typical duration of a grinding process is 10 seconds, the duration of the exploration processing step could be 0.5 seconds. Thus, the micro-action in some embodiments performs some manufacturing aspect with half, a third, a quarter, a tenth, a twentieth, etc. or less of the usual magnitude of that aspect during a typical manufacturing process. In some embodiments, a range for the exploration, such as a range of 20 seconds, will also be defined and input into the program 916. In this case for the range of 20 seconds, an optimum policy table will be generated between 0 seconds to 20 seconds, with the training alternating between processing steps that last a duration of 0.5 seconds of the manufacturing process, followed by the increments and for which sensor information is captured, scored, then recorded at the end of each step, so, e.g., every 0.5 seconds, after a small action, e.g., movement, of the equipment. The micro-actions characterize the impact of the process on the material being processed. It generates a policy map which would provide the best course of action in any given state, enabling the model to react to and mitigate differences between expected and actual states.

With this optimum policy table, the exploration will begin with, first, measuring the load at a time TO. Then, a processing step occurs via taking an exploration step, e.g., actuating the manufacturing tool for some time duration that is much smaller than the usual time duration for achieving a final desired result of the item to be processed/manufactured. After the processing step that included the micro-action, the iterative exploration method returns to measuring for analysis, e.g., the load is analyzed via a sensor measurement. The program generates a score by comparing the current state of the load to a desired result/outcome for the load, e.g., based on how close the current state is to the desired result. This repeated iteration of processing then measuring occurs until the optimum policy table is filled, until a predetermined score is reached, and/or until an exploration range is exhausted or finished.

The example above shows a simple use case in which one parameter, namely time duration of the manufacturing, is taken into account.

In other embodiments, the exploration mode is performed with the tool having multiple parameters and/or dimensions which the reinforcement learning model can adjust with each micro-action. Examples of such other multiple parameters and/or dimensions include tool actuation distance, tool penetration distance into the load being manufactured, module penetration into a processing tool such as a tape grinder, load movement velocity, tool movement velocity, tool actuation angle, load angle, compression force, closing speed of compression arms, drilling speed, tool torque, etc. Other parameters and/or dimensions corresponding to a specific load manufacturing task are selected based on the manufacturing task to be performed. Increasing the number of adjustable parameters and/or dimensions for the micro-actions of the exploration mode constitutes a scaling up that provides the ability to further optimize the overall process as the subject matter expert would deem necessary. In some embodiments, the exploration mode for action choice with multiple parameters is performed with adjustment for all or some of the multiple parameters being available at each step. In some embodiments for multiple parameter adjustment, the exploration mode for action choice occurs with adjustment of only one of the parameters per exploration segment. Thus, the optimum policy model is developed sequentially with exploring one parameter in a first exploration segment, then another parameter in a second exploration segment that is sequentially after the first exploration segment, etc. Some embodiments include multiple iterations involving multiple parts to train the reinforcement learning model. Adding additional parameters expands the dimensions of the optimum policy table which the reinforcement learning model uses and accesses to govern decision making during a run-time phase.

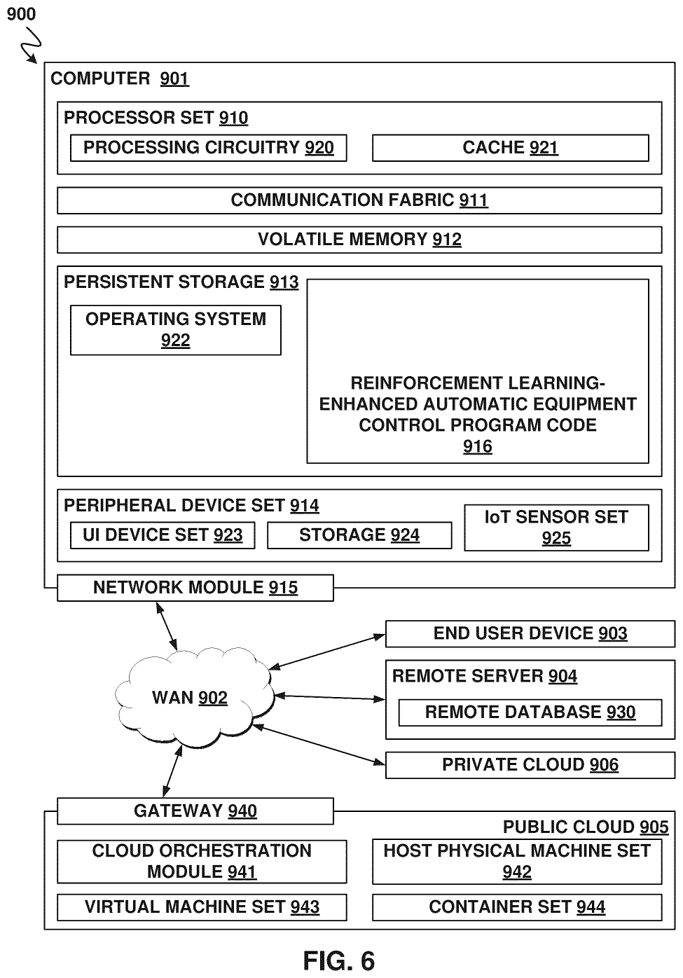

After the optimum policy table is generated, the optimum policy table is saved locally on computer memory that is part of or accessible to the manufacturing tool, e.g., is accessible to the controller of the manufacturing tool. In the embodiment shown in FIG. 6, this computer memory includes the volatile memory 912 and/or the persistent storage 913.

The stored policy table is thereafter accessed and utilized during manufacturing to determine the next best action to undertake that will lead to achieving goals of the user for subsequent builds/manufacturing. The equipment is shifted into a run mode (synonymous with the exploitation mode described above) in which the reinforcement learning model is accessed to guide decision-making but is mostly or completely no longer changed (unless the controller reenters another exploration mode). For example, if for a new manufacturing mode at time TO a next load has a score that matches most closely with the score corresponding to a 1.2 second index of the table and the 13.7 second index is determined to be the optimal score, the following processing step will run for 12.5 seconds as determined by subtracting the head-start (1.2 seconds) from the full time needed (13.7 seconds).

In the run mode, the trained reinforcement learning model is used to help setup the equipment when change in hardware is involved, such as component removal, replacement, or re-alignment. In the run mode, the trained model is also useful and viable in less dramatic situations such as changes in performance due to parts degradation. Parts degradation can also be tracked through the reinforcement learning model by comparing actual vs expected results between iterations within the process and subsequent operations.

The techniques of the present embodiments shift the manufacturing maintenance paradigm from (1) having an engineer or technician adjusting hardware of a tool to be in agreement with the software to (2) the software adjusting itself to be in agreement with the hardware and/or the software automatically recognizing hardware adjustments to recommend and/or to automatically effectuate. Carrying out this shift will reduce the skill difficulty required to maintain a tool while simultaneously providing an avenue for optimizing a process. The requirements to maintain equipment and account for parts that become degraded over time are significantly reduced. The present embodiments provide a more hands-off approach to optimizing equipment and help extend the equipment lifetime of manufacturing equipment, e.g., as the state of the equipment is better monitored to adapt to degradation of parts.

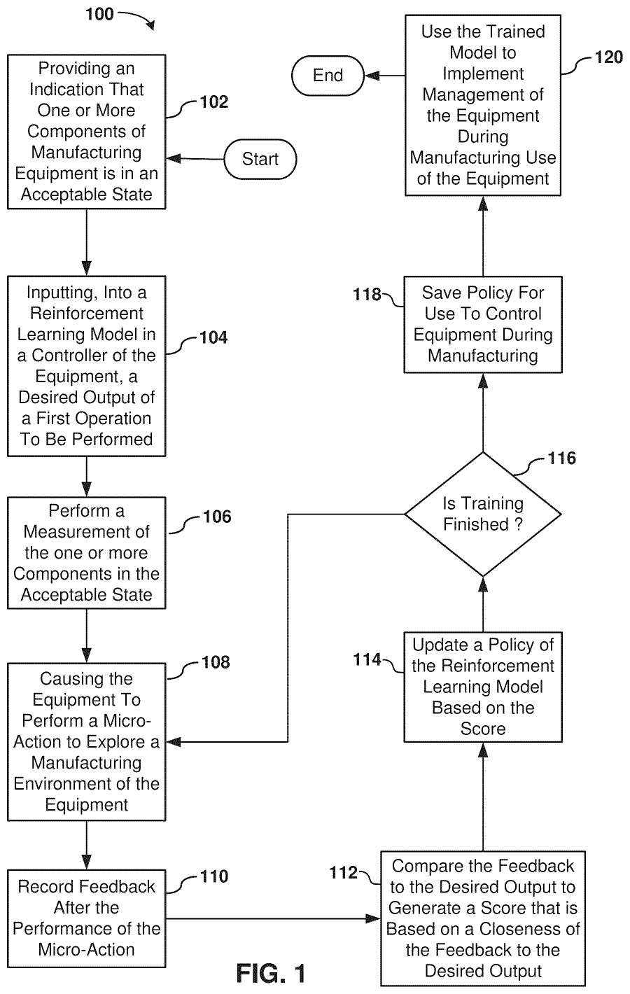

FIG. 1 illustrates a process 100 for reinforcement learning-enhanced automated control of manufacturing equipment according to at least one embodiment. This reinforcement learning-enhanced control process 100 is in at least some embodiments carried out via the reinforcement learning-enhanced automatic equipment control program code 916 that is described subsequently and shown in the computing environment 900 of FIG. 6.

In step 102 of the reinforcement learning-enhanced automated control of manufacturing equipment process 200, an indication is provided that one or more components of manufacturing equipment is in an acceptable state. This step is performed via one or more agents providing an input into the reinforcement learning-enhanced automatic equipment control program code 916, e.g., via an input device (e.g., keyboard, microphone, touch screen display, etc.) of the computer 901. In some embodiments step 102 is performed via initiation of the program code 916 and the program code 916 in a default state initially proceeds into a training portion of the process 200.

The acceptable state of step 102 refers in some embodiments to the component(s) being in a non-degraded state. For example, for a bevel tool the indication of step 102 is provided as a result of and/or in response to a new batch of diamond tape being installed into the manufacturing tool. Such indication occurs in some embodiments in response to a new load of the raw material to be acted upon via the manufacturing process. In the module beveling process, this raw material refers to a new module being added in position on the screen. Thus, the diamond tape is assumed to have a maximum surface roughness (e.g., Ra value) upon the new batch being installed and before any grinding operation with the new tape has been performed. The surface roughness value decreases over time as the diamond tape is used via the manufacturing tool to bevel the edges of the tape reader module.

In some embodiments, the indication of step 200 is provided even though one or more replaceable components are not newly installed. Thus, the reinforcement learning can be initiated with the equipment and one or more its sub-components being in some sub-optimal but acceptable state, e.g., whereby manufacturing is still performable with the equipment to produce a final desired product from a raw material.

In step 104 of the reinforcement learning-enhanced automated control of manufacturing equipment process 100, a desired output is input into a reinforcement learning model in a controller of the equipment. The desired output refers to a state of an item or product that is to be produced via a manufacturing operation with the manufacturing equipment. For example, for a tape reader module beveling process the information is input of the size and location of the bevel(s) that is/are to be added to the module. In some instances, that information is provided with the reverse information, namely the size, width, angle, etc. of the module surface and/or edge after the bevel is completed. This step is performed via one or more agents providing an input into the reinforcement learning-enhanced automatic equipment control program code 916, e.g., via an input device (e.g., keyboard, microphone, touch screen display, etc.) of the computer 901. In some embodiments, a sensor, e.g., a camera and/or ultrasound sensor, which is part of or associated with the manufacturing equipment and/or computer 901 measures a final product in order to determine the desired output for step 104.

In step 106 of the reinforcement learning-enhanced automated control of manufacturing equipment process 100, a measurement of the one or more components of the manufacturing equipment in the acceptable state is performed. This measurement is performed via one or more sensors connected to or communicating with the controller of the manufacturing equipment. The measurement measures a size and/or position of various components. In some embodiments, the reference to the component refers to an object to be processed and changed into the final manufactured process as part of the manufacturing with the manufacturing equipment. In some embodiments, the reference to the component refers to a tool of the manufacturing equipment which operates on an object to be processed and causes a change of such object as part of the manufacturing with the manufacturing equipment. In some embodiments, the reference to the component refers to a tool of the manufacturing equipment which is actuated as part of the manufacturing action but does not directly contact the object that is being processed/adjusted as part of the manufacturing with the manufacturing equipment.

In step 108 of the reinforcement learning-enhanced automated control of manufacturing equipment process 100, the equipment and the component(s) are caused to perform a manufacturing micro-action. The micro-action refers to a processing step which is part of the overall usual manufacturing process but is performed as a fraction of the typical processing step, e.g., as a fraction in magnitude, time, etc., For example: if the typical duration of a grinding process is 10 seconds, the duration of the exploration processing step could be 0.5 seconds. Thus, the micro-action in some embodiments performs some manufacturing aspect with half, a third, a quarter, a tenth, a twentieth, etc. or less of the usual magnitude of that aspect during a typical manufacturing process.

In step 110 of the reinforcement learning-enhanced automated control of manufacturing equipment process 100, feedback is recorded after the performance of the micro-action. This feedback is recorded via a measurement of the one or more components of the manufacturing equipment after the micro-action is performed. For example, the micro-action is performed and the position of each component is maintained while the manufacturing stops. The components are not moved back into an initial position but instead are measured based on the position they held when the micro-action ended. This measurement of step 110 is performed via one or more sensors connected to or communicating with the controller of the manufacturing equipment. The measurement measures a size and/or position of various components. In some embodiments, the reference to the component refers to an object to be processed and changed into the final manufactured process as part of the manufacturing with the manufacturing equipment. In some embodiments, the reference to the component refers to a tool of the manufacturing equipment which operates on an object to be processed and causes a change of such object as part of the manufacturing with the manufacturing equipment. In some embodiments, the reference to the component refers to a tool of the manufacturing equipment which is actuated as part of the manufacturing action but does not directly contact the object that is being processed/adjusted as part of the manufacturing with the manufacturing equipment.

In step 112 of the reinforcement learning-enhanced automated control of manufacturing equipment process 100, the feedback that was recorded from step 110 is compared to the desired output to generate a score that is based on a closeness of the feedback to the desired output. The program code 916 includes a formula for generating the score that is based on a closeness of the feedback to the desired output. In some embodiments, the score represents a percentage of a feature that is produced up to that point of the process at the end of this particular micro-action. Thus, if the manufacturing overall process is to produce a bevel that is 20 degrees and the recorded feedback is that the micro-action produced a bevel of 5 degrees, then the score would be 25.

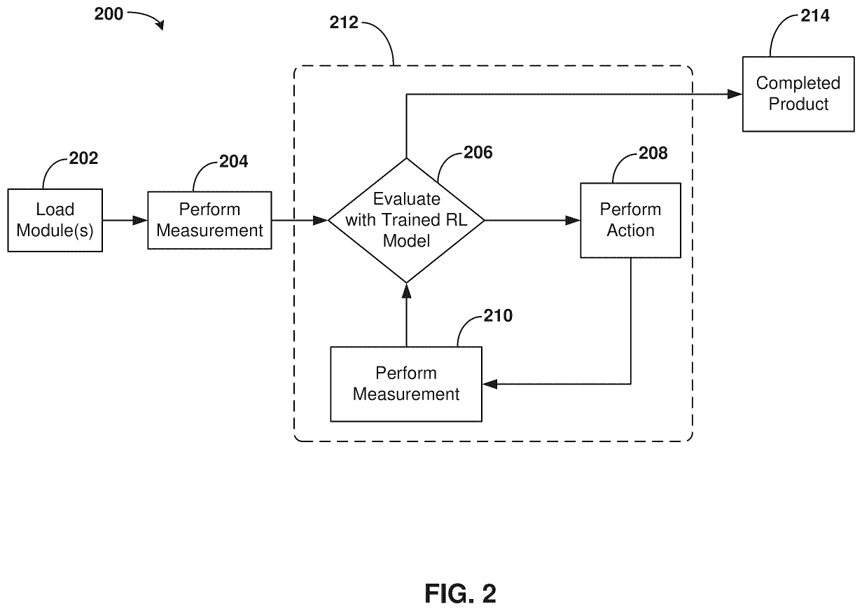

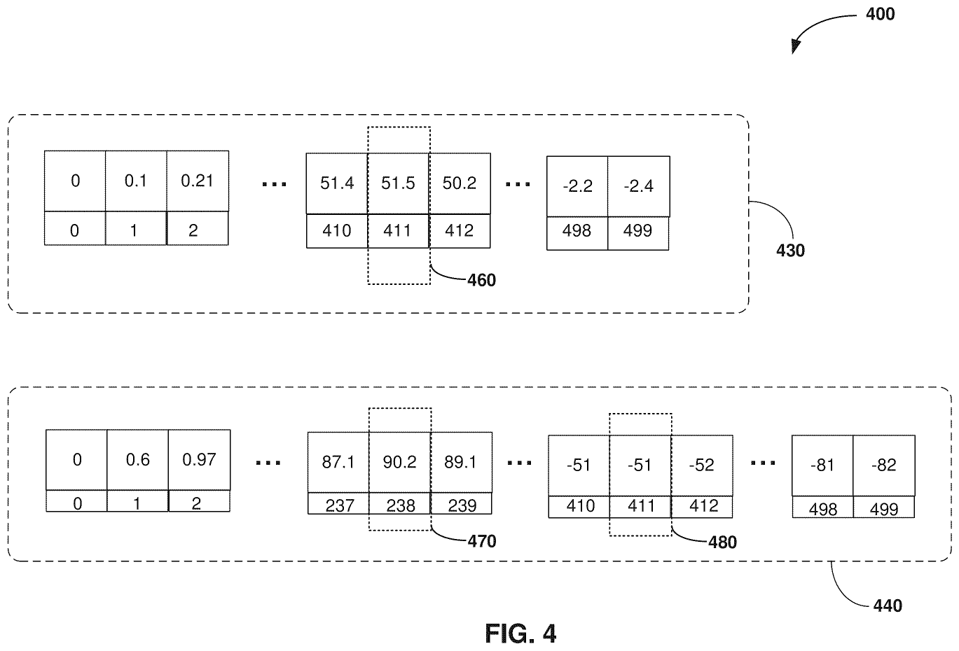

FIG. 4 illustrates aspects of step 112 and shows a comparison 400 of scores produced that are part of reinforcement learning model training before and after equipment maintenance according to one embodiment for a lapping process. FIG. 4 shows that the comparison 400 includes a first set of scores 430 generated before equipment maintenance being compared to a second set of scores 440 generated after equipment maintenance. In the first set 430, the top row shows a number of scores that were generated after a number of manufacturing cycles were completed. Each box in the top row corresponds to a box in the bottom row. The number in the boxes of the bottom row indicate a cycle number of the manufacturing process. The cycle refers to one iteration of the iterative loop 212 shown in FIG. 2: action, measurement, evaluation. Thus, in the first set of scores 430 after 1 cycle the load being modified/manufactured had a measurement which when compared to the desired output generated a score of 0.1. After 2 cycles the load being modified/manufactured had a measurement which when compared to the desired output generated a score of 0.21. In the first set 430, a highest score is achieved at first block 460 which included a score of 51.5 on the 411^{th} cycle. In contrast to the first set 430, the second set of scores 440 had its high score of 90.2 at the 238^{th} manufacturing cycle. If the training of the first set 430 was used to guide equipment usage after equipment maintenance, then the process would have proceeded for 411 cycles in an attempt to achieve the highest score and to make the product be closest to the desired output. However, the second set 440 shows that the score after 411 cycles was negative fifty-one (−51) which is not the highest score. In addition, a negative score can be indicative of an undesirable or unsalvageable result. Thus, the comparison 400 shows that the reinforcement learning policy of the program code 916 needs a retraining after equipment maintenance occurs, e.g., after a new set of diamond grinding paper is applied to the bevel machine.

In various embodiments, the feedback involved in steps 110 and 112 includes a measurement of an item to be manufactured by using the manufacturing equipment. The desired output from step 112 includes a final-state measurement of an item that is manufactured by using the manufacturing equipment. The final-state measurement is generated via measurements of one or more sensors of the manufacturing equipment or is received from uploaded data that is uploaded into the computer based on product measurements taken elsewhere.

In step 114 of the reinforcement learning-enhanced automated control of manufacturing equipment process 100, a policy of the reinforcement learning model is updated based on the score. A policy refers to a strategy of the reinforcement learning model that the model chooses based on information that is input and/or received that represents some type of information received about the environment of the actor. In some embodiments, the policy is stored in the form of a data table in which a choice of available one or more actions is associated with varying amounts/levels of a variable that represents the input information. For FIG. 4 embodiments, when the equipment has a quality or variable that matches a worn-down state then a certain number of manufacturing cycles are needed to achieve an effect on an object to be manufactured. When the equipment has a quality or variable that matches an optimum state then a different number of manufacturing cycles might be needed to achieve an effect on an object to be manufactured as compared to the equipment in a worn-down state. For example, the equipment produces the final product in a fewer number of cycles and/or in less time with the equipment in optimum state as compared to the equipment in the run-down state. For the first set of scores 430, an entry in a policy table is saved that with equipment in a certain quality a manufacturing actuation cycle should occur four hundred and eleven times to achieve an optimized product. In another iteration of the process 100 that occurs after equipment maintenance, corresponding to the second set of scores 440 another entry in the policy table is saved that with equipment in a certain quality a manufacturing actuation cycle should occur two hundred and thirty eight times to achieve an optimized product.

The policy map constitutes a rudimentary digital twin of the manufacturing environment. The creation of this digital twin occurs via thorough exploration, using many, e.g., thousands, of micro-actions to characterize the manufacturing environment. This technique removes the need to create physics-based simulations and models, which require high precision and understanding of the operation. The advantage of being able to remove this high level of subject matter expertise allows for simpler and quicker creation of a digital twin to be used for manufacturing, which then can be used to automate calibration of manufacturing equipment when there is a significant offset in expected performance vs. actual performance due to equipment replacement, degradation, or similar changes.

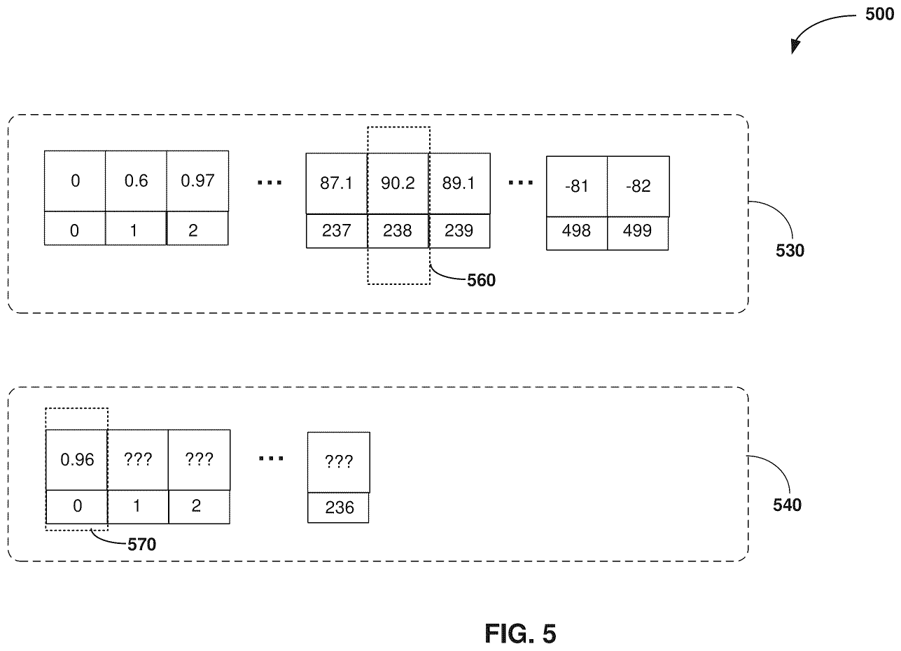

In some embodiments, other entries are saved in the policy table to record the scores for manufacturing cycle segments that did not achieve an optimum score. Such additional information can still help the reinforcement learning model make improved action decisions in future situations. For example FIG. 5 illustrates additional details about a parts variance situation where scores and their corresponding cycles are saved as a set of first parts variance run scores 530. This stored set 530 can be subsequently accessed for future use such as in a second parts variance run (whose scores are shown in the second set 540) so that the reinforcement learning model appropriately guides the operation of the manufacturing equipment.

In step 116 of the reinforcement learning-enhanced automated control of manufacturing equipment process 100, determinations are made whether the training is finished. If the answer is affirmative and the training is finished, the process 100 proceeds to step 120. If the answer is negative and the training is not yet finished, the process 100 proceeds back to step 108 to repeat the steps 108, 110, 112, 114, and 116. This determination of whether training is finished in various embodiments includes one or more of determining whether the optimum policy table is filled, whether a predetermined score (from step 112) is reached, and/or until an exploration range is exhausted or finished. In some embodiments, a range for the exploration, such as a range of 20 seconds, is defined and input into the program 916 to guide the length and number of iterations of micro-actions for the training stage. In this case for the range of 20 seconds, an optimum policy table will be generated between 0 seconds to 20 seconds, with the training alternating between processing steps that last a duration of 0.5 seconds of the manufacturing process. Following each 0.5 second processing step, the manufacturing stops and sensor information is captured and recorded at the end of each step, so, e.g., every 0.5 seconds, after a small action, e.g., movement, of the equipment. Thus, in this 20 second range example, the process 100 would repeat the loop of steps 108, 110, 112, and 114 forty times in order to capture the information for each of these 0.5 second micro-action segments. In this embodiment, the determination of step 116 is performed by comparing the current micro-action iteration to the pre-determined range.

In some embodiments, the evaluation of step 116 also includes a low score threshold triggered from penalties (negative reward scores) or a secondary layer to detect consecutive penalties. Such low score threshold and/or secondary layer is implemented in some embodiments in which over processing is a critical issue. These aspects can also be used to terminate the training early in the event that the training boundaries are too large. There is no need to continue training if the current steps are going to further decrease an already undesirable score. Thus, these barriers helps avoid wasting or consuming parts to recalibrate the system, especially when parts are expensive. Training parts required can scale quickly with parameters controlled.

In step 118 of the reinforcement learning-enhanced automated control of manufacturing equipment process 100, the policy is saved for use to control the equipment during manufacturing. As a part of step 118, the optimum policy table that was updated in step 114 is stored locally on computer memory and/or storage that is part of or accessible to the manufacturing tool, e.g., is accessible to the controller of the manufacturing tool. For example, the computer 901 shown in FIG. 6 is part of or accessible to the manufacturing tool and the optimum policy table is stored in memory such as the persistent storage 913. In other embodiments, the policy table is stored in remote computer memory and/or storage such as in the remote server 904 and remote database 930 and a reinforcement learning model at the computer 901 accesses the remotely stored policy table to guide decision making.

The steps 102 to 118 of the reinforcement learning-enhanced automated control of manufacturing equipment process 100 are considered a training cycle for training the reinforcement learning model. Step 120 then proceeds to a post-training run cycle, e.g., an exploitation cycle.

In step 120 of the reinforcement learning-enhanced automated control of manufacturing equipment process 100, the trained model is used to implement management of the equipment, e.g., calibration of the equipment as needed, during the manufacturing use of the equipment. The reinforcement learning model receives input from the manufacturing environment, e.g., from one or more sensors that are connected to or communicatively associated with the manufacturing equipment. The model inputs that information into the optimum policy table and retrieves action guidance that is associated in the optimum policy table with the specific input information. FIG. 2 shows additional details about step 120 and the use of the trained reinforcement learning model to govern one or more aspects of an automated manufacturing process performed with manufacturing equipment.

FIG. 2 illustrates details about a post-training run cycle 200 in which the trained reinforcement learning model is used to control one or more aspects of the use of the manufacturing equipment according to at least one embodiment. The cycle 200 starts with a module being loaded 202 into the manufacturing equipment. The module refers to new material that is to be processed and/or to new tool parts of the equipment. For the bevel tool example, the module is a new tape reader module that needs its edge to be beveled. A new tool part for the bevel tool example is new diamond grinding tape in some embodiments. After step 202, a measurement 204 of the module and/or equipment is taken, e.g., via one or more sensors associated with the manufacturing equipment. The measurement is captured and the information is transmitted to the program code 916 for storage in the computer 901. After step 204 an iterative loop 212 starts with the trained RL model performing an evaluation of the measurement information from step 204. The evaluation includes accessing and consulting the stored optimum policy table to retrieve a next-best action for the manufacturing equipment to take. After step 206, the retrieved action from step 206 is performed 208 to produce a manufacturing result. After step 208, in step 210 an additional measurement 210 of the processed item is taken, e.g., by one or more sensors that communicate with the manufacturing equipment and the computer 901. After step 210, the new measurement is input back into the trained reinforcement learning model for the trained reinforcement learning model to use that new measurement to input back into the stored optimum policy table to retrieve a next best-action to take. The iterative loop 212 is repeated until the trained reinforcement learning model predicts that the final product is completed and the output of the cycle 200 is a completed product 214. In the beveling tool example, the completed product 214 is the tape reader module with the beveled edge, e.g., with two bevels at −0.2 and 0.2 degrees. In some instances when one or more equipment elements of the manufacturing equipment is in a degraded state, more loops of the iterative loop 212 are necessary to bring the input material into the acceptable state for the final product that is produced.

In various embodiments, the trained reinforcement learning model in the controller as part of step 208 adjust one or more movements of one or more components of the equipment for manufacturing.

In an example, the one or more movements moves the one or more components into a calibrated position to facilitate replacing a first component with a substitute component. The calibrated position is a component replacement position.

In another example, the one or more movements moves the one or more components into a calibrated position after a first component is replaced with a substitute component. The calibrated position is a position for re-initiating operation of the equipment and the substitute component.

In an example, the one or more movements moves the one or more components into a calibrated position in response to sensing material degradation of a first component. The calibrated position is a position for re-initiating operation of the equipment and the first component to compensate for the material degradation. The sensing of the material degradation of the first component occurs via comparing actual results against expected results for iterations of use of the equipment.

In an example, the trained reinforcement learning model controls a duration length of manufacturing that occurs via the one or more movements of the one or more components of the equipment for the manufacturing. In an example, the trained reinforcement learning model controls a number of repeated manufacturing cycles which include the one or more movements of the one or more components of the equipment for the manufacturing.

In an example, the one or more movements moves the one or more components into a calibrated position in response to sensing displacement of one or more components of the equipment. The calibrated position is a realignment position for re-initiating operation of the equipment and a first component.

In an example, a new load to be processed in the manufacturing is measured. A deviance of the measurement from a previous measurement made of a training load is determined. Output of the trained reinforcement learning model for the adjustment of the one or more movements of the one or more components of the equipment for manufacturing is changed based on the deviation.

The various examples of types of actions taken as step 208 that are controlled by next-action decisions of the reinforcement learning model occur in an automated manner, with the controller sending signals to the manufacturing equipment to cause actuation of one, some, or all of the components to perform the respective action as part of the manufacturing process.

In various instances during a post-training manufacturing cycle, the reinforcement learning model uses one or more measurements of one or more elements to determine whether a need for re-training the model exists with the current element state. For example, if a component is in a degraded but still useable state the model compares the measurements of the component to stored measurements about the component taken from training times of the model, determines a deviation based on the comparison, and compares the deviation to a pre-determined threshold. For examples when the threshold is not met, the reinforcement learning model proceeds to perform new training with the equipment in which the respective component is in the degraded but useable state. For examples when an additional second threshold is not met, the reinforcement learning module generates and presents a recommendation to replace the degraded component and/or automatically performs a replacement of the degraded component via automated removal of the degraded component, automated retrieval of a substitute component from storage, and automated insertion of the retrieved substitute component into the manufacturing equipment. This example related to an additional second threshold not being met so that automated replacement or replacement recommendation occurs is referred to as hardware change. An instance when new training is chosen via the reinforcement learning model is described for the score comparison 400 shown in FIG. 4.

FIG. 4 illustrates details about implementing the reinforcement learning-enhanced process for automated control of manufacturing equipment that undergoes a lapping process according to at least one embodiment. FIG. 4 illustrates aspects of step 114 of the process 100 shown in FIG. 1 and shows a comparison 400 of scores produced that are part of reinforcement learning model training before and after equipment maintenance according to one embodiment for a lapping process. FIG. 4 shows that the comparison 400 includes a first set of scores 430 generated before equipment maintenance being compared to a second set of scores 440 generated after equipment maintenance. In the first set 430, the top row shows a number of scores that were generated after a number of manufacturing cycles were completed. Each box in the top row corresponds to a box in the bottom row. The number in the boxes of the bottom row indicate a cycle number of the manufacturing process. Thus, in the first set of scores 430 after 1 cycle the load being modified/manufactured had a measurement which when compared to the desired output generated a score of 0.1. After 2 cycles the load being modified/manufactured had a measurement which when compared to the desired output generated a score of 0.21. In the first set 430, a highest score is achieved at first block 460 which included a score of 51.5 on the 411^{th} cycle. In contrast to the first set 430, the second set of scores 440 had its high score of 90.2 at the 238^{th} manufacturing cycle indicated with block 470. If the training of the first set 430 was used to guide equipment usage after equipment maintenance, then the process would have proceeded for 411 cycles (as shown in block 480) in an attempt to achieve the highest score and to make the product be closest to the desired output. However, the second set 440 shows that the score after 411 cycles was negative fifty-one (−51) which is not the highest score. Thus, the comparison 400 shows that the reinforcement learning policy of the program code 916 needs a retraining after equipment maintenance occurs, e.g., after a new set of diamond grinding paper is applied to the bevel machine.

FIG. 5 illustrates additional details about implementing the reinforcement learning-enhanced process for automated control of manufacturing equipment that undergoes the lapping process according to at least one embodiment. FIG. 5 illustrates additional details about a parts variance situation 500 where scores and their corresponding cycles are saved as a set of first parts variance run scores 530. During the training phase when this first set 530 was gathered, the first optimum score 560 was reached on the two hundred and thirty eighth manufacturing cycle. This first optimum score 560 of 90.2 indicated that the module receiving a bevel had its most optimum bevel size after the two hundred and thirty eighth manufacturing cycle. For the scores determined in fewer total cycles (e.g., before that 238^{th} specific cycle), the scores were all lower than 90.2. For the scores determined in additional cycles (e.g., after that 238^{th} cycle) the scores also became lower. Each of the scores along with the associated cycle number is stored as part of an optimum policy table that is used by the reinforcement learning model.

For a second manufacturing segment that produces a second set of scores 540, a new load is installed into the manufacturing equipment but the initial measurement of step 204 (whose initial information set is labelled as 570 in FIG. 5) indicates that the score before any cycle is performed is not zero but instead is 0.96. Thus, because this initial score of 0.96 does not match the initial score (0) of the first set 530 the reinforcement learning model recognizes that an adjustment of the policy should be explored. The reinforcement learning model checks if the scores from any intermediate cycles better matches the 0.96 score than it matches the zero score of the pre-cycle measurement of the first set 530. The reinforcement learning module performs automated numerical comparison of saved scores from the first set 530 to determine that the score (0.97) of the second (2) cycle of the first set 530 is closest to the 0.96 score of the initial information. Then the reinforcement learning module chooses to adjust the total number of manufacturing cycles that are to be run for this post-training cycle that occurs and produces the second set of scores 540. The adjustment in the present case is to take the cycle number (2) of the match and subtract that from the initial intended number (238) of total cycles. Thus, based on the initial non-zero score in the post-training cycle for this example the reinforcement learning module causes the equipment to perform 236 (=238 minus 2) total cycles to attempt to achieve the optimum material modification to achieve an optimum final product. The initial non-zero score for 570 of the second set 540 is produced due to a parts variance as compared to the parts used in the training set for the first set 530.

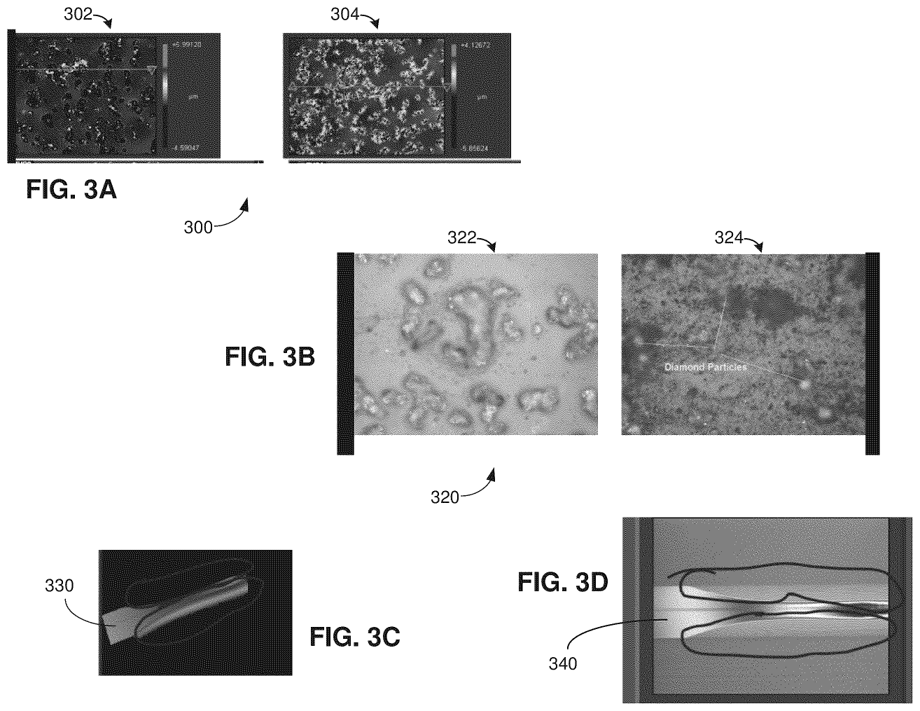

FIG. 3A illustrates details of change in surface roughness of diamond paper that is used to sand edges of a tape reader module according to one embodiment and whose effects are governed by reinforcement learning techniques described herein. FIG. 3A shows a comparison 300 between the 3D surface profiles of an unused diamond tape sample 302 and a used diamond tape sample 304. Due to use, the surface roughness Ra value of the diamond tape changes over time and can affect the length of time needed to produce an acceptable bevel in the manufacturing equipment or in a similar length of time produces a smaller bevel. FIG. 3B illustrates another sample in optical high magnification view that shows change in surface roughness of diamond paper that is used to sand edges of a tape reader module according to one embodiment and whose effects are governed by reinforcement learning techniques described herein. FIG. 3B shows a second comparison view 320 of an unused diamond tape sample 322 and a used diamond tape sample 324. Due to use, the surface roughness of the diamond tape reduces over time and affects the length of time needed to produce an acceptable bevel in the manufacturing equipment or in a similar length of time produces a smaller bevel.

FIG. 3C shows a 3D profile of half of a tape reader module 330 whose edges are beveled according to one embodiment with the beveling process governed by reinforcement learning techniques described herein. Upper and lower edges of the tape reader module 330 are circled in FIG. 3C to indicate the location of the bevels that are applied via the manufacturing equipment that uses reinforcement learning techniques. FIG. 3D shows a second cross-section of a tape reader module 340 whose edges are beveled according to one embodiment with the beveling process governed by reinforcement learning techniques described herein. Upper and lower edges of the tape reader module 340 are circled in FIG. 3D to indicate the location of the bevels that are applied via the manufacturing equipment that uses reinforcement learning techniques.

It may be appreciated that FIGS. 1-5 provide only illustrations of certain embodiments and do not imply any limitations with regard to how different embodiments may be implemented. Many modifications to the depicted embodiment(s), e.g., to particular steps, elements, and/or order of depicted methods or components of a manufacturing device with a reinforcement learning module in the controller, may be made based on design and implementation requirements.

Various embodiments include a method and system for automated manufacturing equipment calibration and setup using reinforcement learning (RL) model integrated into equipment controller. A manufacturing equipment is run in a training mode to train a RL model. The training includes iteratively loading in a part to undergo a manufacturing operation by the manufacturing equipment, describing a scope of the manufacturing operation, having the system perform micro-actions to explore its new environment and begin training the RL model. The trained RL model is employed to help setup the manufacturing equipment when a change in hardware is involved, such as component removal, replacement, or re-alignment or when a change in performance occurs due to parts degradation. Parts degradation is tracked through the RL model by comparing actual vs expected results between iterations of use of the manufacturing equipment. These steps enable software for manufacturing equipment to adapt to hardware setup causing extension of manufacturing equipment lifetime as it can adapt to parts degradation.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 900 in FIG. 6 contains an example of an environment for the execution of at least some of the computer code involved in performing the inventive methods, such as reinforcement learning-enhanced automatic equipment control program code 916. In addition to reinforcement learning-enhanced automatic equipment control program code 916, computing environment 900 includes, for example, computer 901, wide area network (WAN) 902, end user device (EUD) 903, remote server 904, public cloud 905, and private cloud 906. In this embodiment, computer 901 includes processor set 910 (including processing circuitry 920 and cache 921), communication fabric 911, volatile memory 912, persistent storage 913 (including operating system 922 and reinforcement learning-enhanced automatic equipment control program code 916, as identified above), peripheral device set 914 (including user interface (UI) device set 923, storage 924, and Internet of Things (IoT) sensor set 925), and network module 915. Remote server 904 includes remote database 930. Public cloud 905 includes gateway 940, cloud orchestration module 941, host physical machine set 942, virtual machine set 943, and container set 944.

COMPUTER 901 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 930. As is well understood in the art of computer technology, and depending upon the technology, performance of a computer-implemented method may be distributed among multiple computers and/or between multiple locations. On the other hand, in this presentation of computing environment 900, detailed discussion is focused on a single computer, specifically computer 901, to keep the presentation as simple as possible. Computer 901 may be located in a cloud, even though it is not shown in a cloud in FIG. 9. On the other hand, computer 901 is not required to be in a cloud except to any extent as may be affirmatively indicated.

PROCESSOR SET 910 includes one, or more, computer processors of any type now known or to be developed in the future. Processing circuitry 920 may be distributed over multiple packages, for example, multiple, coordinated integrated circuit chips. Processing circuitry 920 may implement multiple processor threads and/or multiple processor cores. Cache 921 is memory that is located in the processor chip package(s) and is typically used for data or code that should be available for rapid access by the threads or cores running on processor set 910. Cache memories are typically organized into multiple levels depending upon relative proximity to the processing circuitry. Alternatively, some, or all, of the cache for the processor set may be located “off chip.” In some computing environments, processor set 910 may be designed for working with qubits and performing quantum computing.

Computer readable program instructions are typically loaded onto computer 901 to cause a series of operational steps to be performed by processor set 910 of computer 901 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 921 and the other storage media discussed below. The program instructions, and associated data, are accessed by processor set 910 to control and direct performance of the inventive methods. In computing environment 900, at least some of the instructions for performing the inventive methods may be stored in reinforcement learning-enhanced automatic equipment control program code 916 in persistent storage 913.

COMMUNICATION FABRIC 911 is the signal conduction path that allows the various components of computer 901 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 912 is any type of volatile memory now known or to be developed in the future. Examples include dynamic type random access memory (RAM) or static type RAM. Typically, volatile memory 912 is characterized by random access, but this is not required unless affirmatively indicated. In computer 901, the volatile memory 912 is located in a single package and is internal to computer 901, but, alternatively or additionally, the volatile memory may be distributed over multiple packages and/or located externally with respect to computer 901.

PERSISTENT STORAGE 913 is any form of non-volatile storage for computers that is now known or to be developed in the future. The non-volatility of this storage means that the stored data is maintained regardless of whether power is being supplied to computer 901 and/or directly to persistent storage 913. Persistent storage 913 may be a read only memory (ROM), but typically at least a portion of the persistent storage allows writing of data, deletion of data and re-writing of data. Some familiar forms of persistent storage include magnetic disks and solid state storage devices. Operating system 922 may take several forms, such as various known proprietary operating systems or open source Portable Operating System Interface-type operating systems that employ a kernel. The code included in model-generated code evaluation with reinforcement learning-enhanced automatic equipment control program code 916 typically includes at least some of the computer code involved in performing the inventive methods.

PERIPHERAL DEVICE SET 914 includes the set of peripheral devices of computer 901. Data communication connections between the peripheral devices and the other components of computer 901 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 923 may include components such as a display screen, speaker, microphone, wearable devices (such as goggles and smart watches), keyboard, mouse, printer, touchpad, game controllers, and haptic devices. Storage 924 is external storage, such as an external hard drive, or insertable storage, such as an SD card. Storage 924 may be persistent and/or volatile. In some embodiments, storage 924 may take the form of a quantum computing storage device for storing data in the form of qubits. In embodiments where computer 901 is required to have a large amount of storage (for example, where computer 901 locally stores and manages a large database) then this storage may be provided by peripheral storage devices designed for storing exceptionally large amounts of data, such as a storage area network (SAN) that is shared by multiple, geographically distributed computers. IoT sensor set 925 is made up of sensors that can be used in Internet of Things applications. For example, one sensor may be a thermometer and another sensor may be a motion detector.

NETWORK MODULE 915 is the collection of computer software, hardware, and firmware that allows computer 901 to communicate with other computers through WAN 902. Network module 915 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 915 are performed on the same physical hardware device. In other embodiments (for example, embodiments that utilize software-defined networking (SDN)), the control functions and the forwarding functions of network module 915 are performed on physically separate devices, such that the control functions manage several different network hardware devices. Computer readable program instructions for performing the inventive methods can typically be downloaded to computer 901 from an external computer or external storage device through a network adapter card or network interface included in network module 915.

WAN 902 is any wide area network (for example, the internet) capable of communicating computer data over non-local distances by any technology for communicating computer data, now known or to be developed in the future. In some embodiments, the WAN 902 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 903 is any computer system that is used and controlled by an end user (for example, a customer of an enterprise that operates computer 901) and may take any of the forms discussed above in connection with computer 901. EUD 903 typically receives helpful and useful data from the operations of computer 901. For example, in a hypothetical case where computer 901 is designed to provide a recommendation to an end user, this recommendation would typically be communicated from network module 915 of computer 901 through WAN 902 to EUD 903. In this way, EUD 903 can display, or otherwise present, the recommendation to an end user. In some embodiments, EUD 903 may be a client device, such as thin client, heavy client, mainframe computer, desktop computer and so on.

REMOTE SERVER 904 is any computer system that serves at least some data and/or functionality to computer 901. Remote server 904 may be controlled and used by the same entity that operates computer 901. Remote server 904 represents the machine(s) that collect and store helpful and useful data for use by other computers, such as computer 901. For example, in a hypothetical case where computer 901 is designed and programmed to provide a recommendation based on historical data, then this historical data may be provided to computer 901 from remote database 930 of remote server 904.

PUBLIC CLOUD 905 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 905 is performed by the computer hardware and/or software of cloud orchestration module 941. The computing resources provided by public cloud 905 are typically implemented by virtual computing environments that run on various computers making up the computers of host physical machine set 942, which is the universe of physical computers in and/or available to public cloud 905. The virtual computing environments (VCEs) typically take the form of virtual machines from virtual machine set 943 and/or containers from container set 944. It is understood that these VCEs may be stored as images and may be transferred among and between the various physical machine hosts, either as images or after instantiation of the VCE. Cloud orchestration module 941 manages the transfer and storage of images, deploys new instantiations of VCEs and manages active instantiations of VCE deployments. Gateway 940 is the collection of computer software, hardware, and firmware that allows public cloud 905 to communicate through WAN 902.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 906 is similar to public cloud 905, except that the computing resources are only available for use by a single enterprise. While private cloud 906 is depicted as being in communication with WAN 902, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 905 and private cloud 906 are both part of a larger hybrid cloud.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

The flowchart and block diagrams in the Figures illustrate the architecture, functionality, and operation of possible implementations of systems, methods, and computer program products according to various embodiments. In this regard, each block in the flowchart, pipeline, and/or block diagrams may represent a module, segment, or portion of instructions, which comprises one or more executable instructions for implementing the specified logical function(s).

What is claimed is:

1. A computer-implemented method comprising:
training a reinforcement learning model that is installed in a controller of equipment, the training comprising:
inputting, into the reinforcement learning model, a desired output of a first operation to be performed via the equipment,
causing the equipment to perform a manufacturing micro-action,
recording feedback from one or more sensors after the performance of the micro-action,
comparing the feedback to the desired output to generate a score that is based on a closeness of the feedback to the desired output,
updating a policy of the reinforcement learning model based on the score, and
iteratively repeating micro-actions, feedback recording, comparison-based score generation, and policy updating multiple times such that the reinforcement learning model becomes a trained reinforcement learning model for guiding actions of the equipment.

2. The method of claim 1, wherein the feedback comprises a measurement of an item to be manufactured by using the equipment, and wherein the desired output comprises a final-state measurement of an item that is manufactured by using the equipment.

3. The method of claim 1, further comprising implementing the trained reinforcement learning model in the controller to adjust one or more movements of one or more components of the equipment for manufacturing.

4. The method of claim 3, wherein the one or more movements moves the one or more components into a calibrated position to facilitate replacing a first component with a substitute component, the calibrated position being a component replacement position.

5. The method of claim 3, wherein the one or more movements moves the one or more components into a calibrated position after a first component is replaced with a substitute component, the calibrated position being a position for re-initiating operation of the equipment and the substitute component.

6. The method of claim 3, wherein the one or more movements moves the one or more components into a calibrated position in response to sensing material degradation of a first component, the calibrated position being a position for re-initiating operation of the equipment and the first component to compensate for the material degradation.

7. The method of claim 6, wherein the sensing of the material degradation of the first component occurs via comparing actual results against expected results for iterations of use of the equipment.

8. The method of claim 3, wherein the trained reinforcement learning model controls a duration length of manufacturing that occurs via the one or more movements of the one or more components of the equipment for the manufacturing.

9. The method of claim 3, wherein the trained reinforcement learning model controls a number of repeated manufacturing cycles which include the one or more movements of the one or more components of the equipment for the manufacturing.

10. The method of claim 3, wherein the one or more movements moves the one or more components into a calibrated position in response to sensing displacement of one or more components of the equipment, the calibrated position being a realignment position for re-initiating operation of the equipment and a first component.

11. The method of claim 3, further comprising measuring a new load to be processed in the manufacturing, determining a deviance of the measurement from a previous measurement made of a training load, and changing, based on the deviance, output of the trained reinforcement learning model for the adjustment of the one or more movements of the one or more components of the equipment for the manufacturing.

12. The method of claim 1, further comprising loading a first component into the equipment in order to replace a degraded component of the equipment, wherein the loading occurs before the performance of the micro-action.

13. A computer program product comprising:
one or more computer-readable storage media; and
program instructions stored on the one or more storage media to perform operations comprising:
receiving one or more measurements for manufacturing equipment;
inputting the one or more measurements into a reinforcement learning model to obtain a next-best action to perform via the manufacturing equipment on a load, the next-best action comprising one or more movements of one or more components of the equipment for manufacturing;
causing the manufacturing equipment to automatically perform the obtained next-best action; and
iteratively receiving input regarding the manufacturing, receiving another next-best action based on the input, and causing the manufacturing equipment to perform the received next best action, wherein these iterative steps result in the manufacturing equipment manufacturing a product.

14. The computer program product of claim 13, wherein the one or more movements moves the one or more components into a calibrated position to facilitate replacing a first component with a substitute component, the calibrated position being a component replacement position.

15. The computer program product of claim 13, wherein the one or more movements moves the one or more components into a calibrated position after a first component is replaced with a substitute component, the calibrated position being a position for re-initiating operation of the equipment and the substitute component.

16. The computer program product of claim 13, wherein the one or more movements moves the one or more components into a calibrated position in response to sensing material degradation of a first component, the calibrated position being a position for re-initiating operation of the equipment and the first component to compensate for the material degradation.

17. The computer program product of claim 16, wherein the sensing of the material degradation of the first component occurs via comparing actual results against expected results for iterations of use of the equipment.

18. A computer system comprising:
a processor set;
a set of one or more computer-readable storage media; and
program instructions, collectively stored on the set of one or more storage media, for execution by the processor set to cause computer operations comprising:
training a reinforcement learning model that is installed in a controller of equipment, the training comprising:
inputting, into the reinforcement learning model, a desired output of a first operation to be performed via the equipment and the first component,
causing the equipment to perform a manufacturing micro-action,
recording feedback from one or more sensors after the performance of the micro-action,
comparing the feedback to the desired output to generate a score that is based on a closeness of the feedback to the desired output,
updating a policy of the reinforcement learning model based on the score, and
iteratively repeating micro-actions, feedback recording, comparison-based score generation, and policy updating multiple times such that the reinforcement learning model becomes a trained reinforcement learning model for guiding actions of the equipment.

19. The computer system of claim 18, wherein the feedback comprises a measurement of an item to be manufactured by using the equipment, and wherein the desired output comprises a final-state measurement of an item that is manufactured by using the equipment.

20. The computer system of claim 18, wherein the computer operations further comprise implementing the trained reinforcement learning model in the controller to adjust one or more movements of one or more components of the equipment for manufacturing.
